(19) United States
(12) Patent Application Publication
(10) Pub. No.: US 2025/0222443 A1
(43) Pub. Date: Jul. 10, 2025

(54) SCR Zeolite Catalysts for Reduced N2O Formation

(71) Applicant: Umicore AG & Co. KG, Hanau-Wolfgang (DE)

(72) Inventors: Fei Wen, Kahl am Main (DE); Ruediger Hoyer, Alzenau-Hoerstein (DE); Frank-Walter Schuetze, Aschaffenburg (DE); Yvonne Demel, Altenstadt (DE); Stephan Eckhoff, Alzenau (DE)

(21) Appl. No.: 18/847,714

(22) PCT Filed: Mar. 23, 2023
(86) PCT No.: PCT/EP2023/057509

§ 371 Date: Sep. 17, 2024

(30) Foreign Application Priority Data
Mar. 23, 2022 (EP) 22163781.2

(51) Int. Cl. B01J 29/76; B01J 37/02; F01N 3/20; F01N 3/28

(52) U.S. Cl. CPC B01J 29/763; B01J 37/0246; F01N 3/20; F01N 3/281

(57) ABSTRACT

The present invention discloses a crystalline aluminosilicate small-pore zeolite having a maximum ring size of eight tetrahedral atoms, wherein the zeolite comprises copper, wherein the Cu:Al atomic ratio is between 0.12 and 0.55; and a metal M1, which is calcium, magnesium, or strontium, wherein the M1:Cu atomic ratio is between 0.05 and 0.95; and a metal M2, wherein M2 is selected from magnesium, calcium, barium, strontium, yttrium, titanium, zirconium, niobium, iron, zinc, silver, lanthanum, cerium, praseodymium, neodymium, promethium, samarium, europium, gadolinium, terbium, dysprosium, holmium, erbium, thulium, ytterbium, lutetium and mixtures thereof, and wherein M1 and M2 are different from one another, and wherein the M2:Cu atomic ratio is between 0.05 and 0.80; and wherein the sum of the atomic ratios of copper, metal M1 and metal M2 to aluminum, (Cu+M1+M2):Al, is between 0.20 and 0.80; and wherein the zeolite comprises at least 2.5 wt.-% of copper, calculated as CuO and based on the total weight of the zeolite. Catalyst substrate monoliths comprising the crystalline aluminosilicate zeolite are also disclosed. These catalyst substrate monoliths can be used in a process for the removal of nitrogen oxides from combustion exhaust gases, and they can be part of emissions treatment systems.

The present invention relates to catalytically active compositions for the selective catalytic reduction of nitrogen oxides from the exhaust gas of combustion engines. In particular, it deals with small-pore zeolites being promoted with copper, a metal M1 which is calcium, magnesium or strontium, and a metal M2 which is selected from calcium, magnesium, barium, strontium, yttrium, titanium, zirconium, niobium, iron, zinc, silver, lanthanum, cerium, praseodymium, neodymium, promethium, samarium, europium, gadolinium, terbium, dysprosium, holmium, erbium, thulium, ytterbium, lutetium and mixtures thereof, and wherein M1 and M2 are not identical. Methods for making these catalytically active compositions as well as uses thereof are also envisaged.

Zeolites are crystalline microporous aluminosilicate materials formed by corner-sharing TO₄ tetrahedra, wherein T stands for silicon (Si) or aluminum (Al), said tetrahedra being interconnected by oxygen atoms to form pores and cavities of uniform size and shape precisely defined by their crystal structure. Zeolites are also denoted “molecular sieves” because the pores and cavities are of similar size as small molecules. This class of materials has important commercial applications as adsorbents, ion-exchangers and catalysts.

Zeolites are classified by the International Zeolite Association (IZA) according to the rules of the IUPAC Commission on Zeolite Nomenclature. Once the topology of a new framework is established, a three letter code is assigned. This code defines the atomic structure of the framework, from which a distinct X-ray diffraction pattern can be described.

It is also common to classify zeolites according to their pore size which is defined by the ring size of the biggest pore aperture. Zeolites with a large pore size have a maximum ring size of 12 tetrahedral atoms, zeolites with a medium pore size have a maximum pore size of 10 and zeolites with a small pore size have a maximum pore size of 8 tetrahedral atoms. Well-known small-pore zeolites belong in particular to the AEI, CHA (chabazite), ERI (erionite), LEV (levyne) and KFI framework types. Examples having a large pore size are zeolites of the faujasite framework type.

There are a large number of molecular sieve structures known today. Some known molecular sieves belong to certain families of structures with similar features. One specific family, the ABC-6 family, can be described as a stacking of two-dimensional periodic layers of non-connected planar 6-ring motifs, made up from 6 T-atoms (T=Si, Al etc.) connected by oxygen atoms. The resulting layer with hexagonal symmetry is also called the periodic building unit (PerBU). The stacking is typically described by a sequence of letters “A”, “B” and “C” that indicates the relative positions of neighboring layers. “A”, “B” and “C” refers to the well-known relative positions of neighboring layers when stacking hexagonal layers of close packed spheres.

The CHA framework belongs to the ABC-6 family and can be described by a repeating stacking sequence of AABBCC. This leads to a framework topology characterized by a three-dimensional 8-membered-ring pore systems containing double-six-rings (d6R) and cha cages.

Small-pore zeolites, in particular if cations like copper and iron are included in the zeolite pores, play an important role as catalysts in the so-called Selective Catalytic Reduction (SCR) of nitrogen oxides with ammonia to form nitrogen and water. The SCR process has been widely used to clean up exhaust gases which result from the combustion of fossil fuels, in particular from stationary power plants and from vehicles powered by diesel engines.

The catalytic reduction of NOₓ with NH₃ can be represented by different reaction equations. Nitric oxide (NO) is the main NOₓ compound produced in an engine. The reduction of NO is referred to as the “standard” NH₃—SCR reaction:

4NO+4NH₃+O₂→4N₂+6H₂O (1)

NO₂ is more reactive than NO. In presence of mixtures of NO and NO₂, the NH₃—SCR reaction is easier, and the so-called “fast” NH₃—SCR reaction can occur:

2NH₃+NO+NO₂→2N₂+3H₂O (2)

To take profit of the fast NH₃—SCR reaction, an additional catalyst is needed to oxidize part of the NO into NO₂.

Also, side reactions may occur and result in unwanted products or the unproductive consumption of ammonia:

4NH₃+3O₂+N₂+6H₂O (3)

2NH₃+2O₂+N₂O+3H₂O (4)

4NH₃+5O₂+4NO+6H₂O (5)

4NH₃+7O₂+4NO₂+6H₂O (6)

2NH₃+2NO₂+H₂O+NH₄NO₂+NH₄NO₃ (7)

In official driving cycles, exhaust gas temperatures of latest generation engines and hybrid vehicles with reduced fuel consumption and low CO₂ emission are significantly lower than with previous engine generations. Therefore, it is necessary to obtain a NH₃-SCR catalyst which shows a high low-temperature NOₓ conversion. In general, Cu-containing zeolites display a better low-temperature NOₓ conversion than their Fe-containing counterparts. Furthermore, NH₃-SCR catalyst should release as little N₂O as possible.

Next to selectivity and activity, the hydrothermal stability of SCR catalysts is another essential parameter, as an NH₃—SCR catalyst has to withstand harsh temperature conditions under full load of the engine and the exposure to water vapor at temperatures up to 700° C. is known to be critical for many zeolite types.

WO 2019/223761 A1 discloses rare element containing zeolitic materials having a framework structure selected from the group AEI, AFT, AFV, AFX, AVL, CHA, EMT, GME, KFI, LEV, LTN and SFW, including mixtures of two or more thereof. Preferably, the zeolitic material has an AEI or CHA framework structure. The framework structure of the zeolitic material comprises SiO₂ and X₂O₃, wherein X stands for a trivalent element, wherein the zeolitic material displays an SiO₂:X₂O₃ molar ratio in the range of from 2 to 20, and wherein the zeolitic material contains one or more rare earth elements as counter-ions at the ion exchange sites of the framework structure. X is selected from the group consisting of Al, Ga and mixtures thereof. The zeolitic material preferably contains one or more transition metals, preferably selected from the group consisting of Fe, Cu, Pt and Pd. Furthermore, the zeolitic materials contains one or more rare earth elements selected from the group consisting of La, Ce, Pr, Nd, Sm, Eu, Gd, Tb, Dy, Ho, Er, Tm, Yb, Lu, Y and Sc, most preferably Yb, Lu, Y and Sc, wherein Y is even more preferred than the other rare earth elements.

In Z Zhao, R Yu, C Shi, H Gies, F-S Xiao, D De Vos, T Yokoi, X Bao, U Kolb, R McGuire, A-N Parvulescu, S Maurer, U Müller and W Zhang: “Rare-earth ion exchanged Cu-SSZ13 zeolite from organotemplate-free synthesis with enhanced hydrothermal stability in NH3-SCR of NOx”, the effect of rare-earth ions on the hydrothermal stability and NO conversion of Cu-SSZ-13 was tested. SSZ-13 zeolites having Si/Al ratios of 4 and 5, corresponding to SAR values of 8 and 10, were ion exchanged with Ce, La, Sm, Y or Yb and subsequently with copper. The zeolites thus obtained had copper contents of between 2.2 and 3.4 wt.-% and rare-earth metal contents of 0 to 2.7 wt.-%. After hydrothermal treating in 10% H₂O/air at 800° C. for 16 h, the NO conversion of the SSZ-13 zeolites was tested. All zeolites that were enriched with rare-earth metal ions showed and enhanced low temperature NO conversion when compared to zeolites that only comprised copper. Among the tested rare-earth ions, yttrium showed significant enhancement of hydrothermal stability and NH₃—SCR activities after hydrothermal aging of Cu-SSZ-13. However, the behavior of the rare-earth metal exchanged zeolites in the fast SCR reaction and their selectivity towards N₂O was not tested.

EP 2 659 973 A1 discloses a chabazite-type zeolite having copper and an alkali earth metal supported thereon. The alkali earth metal is preferably at least one metal selected from the group consisting of calcium, magnesium and barium. Moreover, the SiO₂/Al₂O₃ molar ratio is preferably from 10 to 50, and the copper/aluminum atomic ratio is preferably from 0.15 to 0.25. This type of chabazite-type zeolite exhibits a higher nitrogen oxide purification rate after a hydrothermal durability treatment than those of conventional chabazite-type zeolite catalysts on which only copper is supported.

WO 2013/155244 A1 provides a catalyst material useful for the selective catalytic reduction of NOx in lean burn exhaust gas, wherein the catalyst material is a hydrothermally stable, low SAR aluminosilicate zeolite loaded with a synergistic combination of one or more transition metals, such as copper, and one or more alkaline earth metals, such as calcium or potassium. Preferably, the aluminosilicate zeolite is CHA, and the SAR value is between 10 and 25. The zeolite is promoted with a base metal selected from Cr, Mn, Fe, Co, Ni and Cu and mixtures thereof, and with a second promoter metal selected from Na, K, Rb, Cs, Mg, Ca and Ba. The examples show chabazites exchanged with copper and a second metal selected from one of Na, K, Cs, Mg, Ca, Sr or Mn. The molar ratios of the first and the second promoter metal to aluminum are not given, neither per individual promoter metal, nor for the sum thereof.

WO 2019/219623 A1 provides hydrothermally stable crystalline aluminosilicate zeolites with a CHA framework type, wherein the zeolite has a total proton content of less than 2 mmol per gram. The zeolite may comprise 0.1 to 10 wt.-% of at least one transition metal, calculated as the respective oxide and based on the total weight of the zeolite. Preferably, is Cu and/or Fe, most preferably Cu. It may furthermore comprise at least one alkali or alkaline earth metal in a concentration of 0 to 2 wt.-%, calculated as the respective metal and based on the total weight of the zeolite. The alkali or alkaline earth metal is preferably Na and/or K. The invention furthermore provides a one-pot synthesis method for making the aluminosilicate zeolites with a CHA framework type. An aqueous reaction mixture comprising a tetraethylammonium compound, a silica source, at least one alkali or alkaline earth metal hydroxide, a zeolite of the faujasite framework type and Cu-tetraethylenepentamine are mixed, homogenized and heated, and finally, the product is recovered. The novel hydrothermally stable zeolites comprising a CHA framework type are suitable as catalytically active materials for the selective catalytic reduction of nitrogen oxides by reaction with NH₃ as reductant (NH₃—SCR) wherein said hydrothermally stable zeolites are used.

US 2014/112853 A1 discloses compositions and catalytic articles comprising a copper-promoted 8-ring small pore molecular sieve and an iron-promoted 8-ring small pore molecular sieve. The catalytic articles are useful in methods and systems to catalyze the reduction of nitrogen oxides in the presence of a reductant. The zeolite is preferably selected from AEI, AFT, AFX, CHA, EAB, ERI, KFI, LEV, SAS, SAT, and SAV; most preferably, it is CHA. The copper-promoted 8-ring small pore molecular sieve can comprise an alkaline earth metal selected from barium, magnesium, beryllium, calcium, strontium, radium, and combinations thereof. Preferably, the alkaline earth metal is selected from barium, magnesium, calcium and combinations thereof. Most preferably, it is barium. The compositions show an improved low temperature DeNOx performance at significantly lower NH₃ filling level than the copper-promoted Cu-SSZ-13, which is most frequently used in existing SCR catalysts, and a low N₂O selectivity.

WO 2014/062952 A1 describes a selective catalytic reduction catalyst comprising an 8-ring small pore molecular sieve promoted with copper and an alkaline earth component. The catalyst is effective to catalyze the reduction of nitrogen oxides (NOₓ) in the presence of a reductant. A method for selectively reducing nitrogen oxides is also described. The zeolite is selected from AEI, AFT, AFX, CHA, EAB, ERI, KFI, LEV, SAS, SAT and SAV. Preferably, it is CHA. The alkaline earth metal selected from barium, magnesium, beryllium, calcium, strontium, radium, and combinations thereof. Preferably, the alkaline earth metal is selected from barium, magnesium, calcium and combinations thereof. Most preferably, it is barium. The compositions show an improved low temperature DeNOx performance at significantly lower NH₃ filling level than the copper-promoted Cu-SSZ-13, which is most frequently used in existing SCR catalysts. WO 2014/062952 A1 is silent about the N₂O selectivity of the disclosed catalysts.

WO 2015/189680 A1 Described are base metal catalysts that comprise a base metal material in an amount effective to generate an exotherm over a temperature range of 300° C. to 650° C. and to oxidize soot collected by a downstream particulate filter. The base metal catalysts are substantially free of platinum group metals. Emission treatment systems and methods of remediating nitrogen oxides (NOₓ), particulate matter, and gaseous hydrocarbons using base metal catalyst are also described. The base metal material is selected from V, W, Ti, Cu, Fe, Co, Ni, Cr, Mn, Nd, Ba, Ce, La, Pr, Mg, Ca, Zn, Nb, Zr, Mo, Sn, Ta, Ce, and Sr, and combinations thereof. The catalysts may further comprise a molecular sieve selected from AEI, AFT, AFX, CHA, EAB, EMT, ERI, FAU, GME, JSR, KFI, LEV, LTL, LTN, MOZ, MSO, MWW, OFF, SAS, SAT, SAV, SBS, SBT, SFW, SSF, SZR, TSC, WEN, and combinations thereof.

A major drawback of copper-loaded zeolites of the state of the art is that the copper amount must be sufficiently high to achieve acceptable performance in the SCR reaction after aging, but a high copper loading of the zeolite leads to a high N₂O level, which makes it difficult to meet the emission limits according to legislation. The prior art has shown that reducing the amount of copper reduces the N₂O level, but also the NOₓ conversion. If another transition metal or a rare earth metal is added to such a zeolite with a lowered copper amount, the NOₓ conversion increases, but it is still lower than that of zeolites having a high amount of copper alone.

There is a constant need for improved SCR catalysts showing both a good activity for converting nitrogen oxides, but also a good selectivity, meaning that as much nitrogen oxides as possible are converted to nitrogen according to equations (1) and (2) above, but not to NO, NO₂, N₂O or ammonium nitrite and ammonium nitrate according to equations (4) to (7).

### Problem to be Solved by the Invention

It is an object of the present invention to provide catalytically active compositions for the removal of nitrogen oxides from the exhaust gas of combustion engines which show a high NOₓ conversion rate with good durability as well as a good selectivity to nitrogen for this conversion. Another object of the present invention is to provide devices and systems for the treatment of exhaust gases of combustion engines which comprise the catalytically active compositions according to the present invention. Yet another object of the present invention is to provide a method for the abatement of NOₓ emissions, and optionally also particulate matter, from exhaust gases of internal combustion engines.

### Solution of the Problem

The object to provide catalytically active compositions for the removal of nitrogen oxides from the exhaust gas of combustion engines which show high NOx conversion rate with good durability as well as a good selectivity to nitrogen for this conversion is solved by a crystalline aluminosilicate small-pore zeolite having a maximum ring size of eight tetrahedral atoms, wherein the zeolite comprises
copper, wherein the Cu:Al atomic ratio is between 0.12 and 0.55; an
a metal M1, wherein M1 is calcium, magnesium or strontium, and wherein the M1:Cu atomic ratio is between 0.05 and 0.95; and
a metal M2, wherein M2 is selected from magnesium, calcium, barium, strontium, yttrium, titanium, zirconium, niobium, iron, zinc, silver, lanthanum, cerium, praseodymium, neodymium, promethium, samarium, europium, gadolinium, terbium, dysprosium, holmium, erbium, thulium, ytterbium, lutetium and mixtures thereof, and wherein the M2:Cu atomic ratio is between 0.05 and 0.80; and
wherein M1 and M2 are different from one another, and wherein the sum of the atomic ratios of copper, metal M1 and metal M2 to aluminum, (Cu+M1+M2):Al, is between 0.20 and 0.80; and
wherein the zeolite comprises at least 2.5 wt.-% of copper, calculated as CuO and based on the total weight of the zeolite.

The catalytically active compositions for the removal of nitrogen oxides from the exhaust gas of combustion engines and the devices and systems for the treatment of exhaust gases of combustion engines which comprise the catalytically active compositions are explained below, with the invention encompassing all the embodiments indicated below, both individually and in combination with one another.

The selective catalytic reduction of nitrogen oxides is hereinafter referred to as “SCR” or “SCR reaction”.

A “catalytically active composition” is a substance or a mixture of substances which is capable to convert one or more components of an exhaust gas into one or more other components. An example of such a catalytically active composition is, for instance, an oxidation catalyst composition which is capable of converting volatile organic compounds and carbon monoxide to carbon dioxide or ammonia to nitrogen oxides. Another example of such a catalyst is, for example, a selective catalytic reduction catalyst (SCR) composition which is capable of converting nitrogen oxides to nitrogen and water. In the context of the present invention, an SCR catalyst is a catalyst comprising a carrier substrate and a washcoat comprising an SCR catalytically active composition. An ammonia slip catalyst (ASC) is a catalyst comprising a carrier substrate, a washcoat comprising an oxidation catalyst, and a washcoat comprising an SCR catalytically active composition.

A molecular sieve is a material with pores, i.e. with very small holes, of uniform size. These pore diameters are similar in size to small molecules, and thus large molecules cannot enter or be adsorbed, while smaller molecules can. In the context of the present invention, a molecular sieve is zeolitic. Zeolites are made of corner-sharing tetrahedral SiO₄ and AlO₄ units. They are also called “silicoaluminates” or “aluminosilicates”. In the context of the present invention, these two terms are used synonymously.

As used herein, the terminology “non-zeolitic molecular sieve” refers to corner-sharing tetrahedral frameworks wherein at least a portion of the tetrahedral sites are occupied by an element other than silicon or aluminum. If a portion, but not all silicon atoms are replaced by phosphorous atoms, it deals with so-called “silico aluminophosphates” or “SAPOs”. If all silicon atoms are replaced by phosphorous, it deals with aluminophosphates or “AIPOs”.

A “zeolite framework type”, also referred to as “framework type”, represents the cornersharing network of tetrahedrally coordinated atoms. It is common to classify zeolites according to their pore size which is defined by the ring size of the biggest pore aperture. Zeolites with a large pore size have a maximum ring size of 12 tetrahedral atoms, zeolites with a medium pore size have a maximum pore size of 10 and zeolites with a small pore size have a maximum pore size of 8 tetrahedral atoms. Well-known small-pore zeolites belong in particular to the AEI, CHA (chabazite), ERI (erionite), LEV (levyne), AFX and KFI framework. Examples having a large pore size are zeolites of the faujasite (FAU) framework type and zeolite Beta (BEA).

A “zeotype” comprises any of a family of materials based on the structure of a specific zeolite. Thus, a specific “zeotype” comprises, for instance, silicoaluminates, SAPOs and AIPOs that are based on the structure of a specific zeolite framework type. Thus, for example, chabazite (CHA), the silicoaluminates SSZ-13, Linde R and ZK-14, the silicoaluminophosphate SAPO-34 and the aluminophosphate MeAIPO-47 all belong to the chabazite framework type. The skilled person knows which silicoaluminates, silico aluminophosphates and aluminophosphates belong to the same zeotype. Furthermore, zeolitic and non-zeolitic molecular sieves belonging to the same zeotype are listed in the database of the International Zeolite Association (IZA). The skilled person can use this knowledge and the IZA database without departing from the scope of the claims.

The silica to alumina ratio (SiO₂:Al₂O₃) of the zeolites is hereinafter referred to as the “SAR value”.

A “catalyst carrier substrate”, also just called a “carrier substrate” is a support to which the catalytically active composition is affixed and shapes the final catalyst. The carrier substrate is thus a carrier for the catalytically active composition.

A “washcoat” as used in the present invention is an aqueous suspension of a catalytically active composition and optionally at least one binder. Materials which are suitable binders are, for example, aluminum oxide, titanium dioxide, silicon dioxide, zirconium dioxide, cerium dioxide, or mixtures thereof, for example mixtures of silica and alumina.

A washcoat which has been affixed to a catalyst carrier substrate is called a “coating”. It is also possible to affix two or more washcoats to the carrier substrate. The skilled person knows that affixing two or more washcoats onto one single carrier substrate is possible by “layering” or by “zoning”, and it is also possible to combine layering and zoning. In case of layering, the washcoats are affixed successively onto the carrier substrate, one after the other. The washcoat that is affixed first and thus in direct contact with the carrier substrate represents the “bottom layer”, and the washcoat that is affixed last is the “top layer”. In case of zoning, a first washcoat is affixed onto the carrier substrate from a first face side A of the carrier substrate towards the other face side B, but not over the entire length of the carrier substrate, but only to an endpoint which is between face sides A and B. Afterwards, a second washcoat is affixed onto the carrier, starting from face side B until an endpoint between face sides B and A. The endpoints of the first and the second washcoat need not be identical: if they are identical, then both washcoat zones are adjacent to one another. If, however, the endpoints of the two washcoat zones, which are both located between face sides A and B of the carrier substrate, are not identical, there can be a gap between the first and the second washcoat zone, or they can overlap. As mentioned above, layering and zoning can also be combined, if, for instance, one washcoat is applied over the entire length of the carrier substrate, and the other washcoat is only applied from one face side to an endpoint between both face sides.

In the context of the present invention, the “washcoat loading” is the mass of the catalytically active composition per volume of the carrier substrate.

The skilled person knows that washcoats are prepared in the form of suspensions and dispersions.

Suspensions and dispersions are heterogeneous mixtures comprising solid particles and a solvent. The solid particles do not dissolve, but get suspended throughout the bulk of the solvent, left floating around freely in the medium. If the solid particles have an average particle diameter of less than or equal to 1 μm, the mixture is called a dispersion; if the average particle diameter is larger than 1 μm, the mixture is called a suspension. Washcoats in the sense of the present invention comprise a solvent, usually water, and suspended or dispersed particles represented by particles of one or more the catalytically active compositions, and optionally particles of at least one binder as described above. This mixture is often referred to as the “washcoat slurry”. The slurry is applied to the carrier substrate and subsequently dried to form the coating as described above. In the context of the present invention, the term “washcoat suspension” is used for mixtures of solvents, particles of one or more catalytically active compositions, and optionally particles of at least one binder, irrespective of the individual or average particle sizes. This means that in “washcoat suspensions” according to the present invention, the size of individual particles as well as the average particle size of the one or more catalytically active solid particles can be less than 1 μm, equal to 1 μm and/or larger than 1 μm.

The term “mixture” as used in the context of the present invention is a material made up of two of more different substances which are physically combined and in which each ingredient retains its own chemical properties and makeup. Despite the fact that there are no chemical changes to its constituents, the physical properties of a mixture, such as its melting point, may differ from those of the components.

A “catalysed substrate monolith” is a carrier substrate comprising a catalytically active composition. The carrier may be coated with a washcoat comprising the catalytically active composition, wherein the washcoat comprises a catalytically active composition and optionally at least one binder. Alternatively, the catalytically active composition can be a component of the carrier substrate itself.

A “device” as used in the context of the present invention is a piece of equipment designed to serve a special purpose or perform a special function. The catalytic devices according to the present invention serve the purpose and have the function to remove nitrogen oxides from the exhaust gas of combustion engines. A “device” as used in the present invention may consist of one or more catalyst, also called “catalytic articles” or “bricks” as defined above.

“Upstream” and “downstream” are terms relative to the normal flow direction of the exhaust gas in the exhaust pipeline. A “zone or catalyst 1 which is located upstream of a zone or catalyst 2” means that the zone or catalyst 1 is positioned closer to the source of the exhaust gas, i.e. closer to the motor, than the zone or catalyst 2. The flow direction is from the source of the exhaust gas to the exhaust pipe. Accordingly, in this flow direction the exhaust gas enters each zone or catalyst at its inlet end, and it leaves each zone or catalyst at its outlet end.

The term “nitrogen oxides”, as used in the context of the present invention, encompasses nitrogen monoxide (NO), nitrogen dioxide (NO₂), and nitrous oxide (N₂O). By contrast, the term “NOₓ”, however, only encompasses NO and NO₂, but not N₂O, although nitrous oxide is also an oxide of nitrogen. This distinction between “nitrogen oxides” and “NOx” is, however, widely used by skilled persons.

The term “NOₓ conversion”, as used in the context of the present invention, means the percent conversion of NOₓ without taking N₂O in the gas phase after the catalyst into account. “N₂O selectivity” means the percent conversion of NOₓ and NH₃ in the gas feed into N₂O.

The N₂O selectivity can be calculated according to the equation

$${S}_{{N}_{2} O} = 2 * \frac{( {N}_{2} {O}_{o u t} - {N}_{2} {O}_{in} )}{( {NH}_{3 , in} - {NH}_{3 , out} + {NO}_{x , in} - {NO}_{x , out} )}$$

Wherein
N₂Oᵢₙ=amount of N₂O at the inlet end of a catalytic device
N₂Oₒᵤₜ=amount of N₂O at the outlet end of a catalytic device
NH_{3,in}=amount of NH₃ at the inlet end of a catalytic device
NH_{3,out}=amount of NH₃ at the outlet end of a catalytic device
NO_{x,in}=amount of NOₓ at the inlet end of a catalytic device
NO_{x,out}=amount of NOₓ at the outlet end of a catalytic device

The “catalytic activity” or just “activity” is the increase in rate of a chemical reaction caused by the presence of a catalytically active composition.

The skilled person knows that the SCR reaction requires a reductant to reduce nitrogen oxides to nitrogen and water. A suitable reductant is ammonia, and the SCR reaction in presence of ammonia is known as “NH₃—SCR”. The ammonia used as reducing agent may be made available by feeding liquid or gaseous ammonia or an ammonia precursor compound into the exhaust gas. If an ammonia precursor is used, it is thermolyzed and hydrolyzed to form ammonia. Examples of such ammonia precursors are ammonium carbamate, ammonium formate and preferably urea. Alternatively, the ammonia may be formed by catalytic reactions of the ammonia precursor within the exhaust gas.

Suitable crystalline aluminosilicate small-pore zeolites having a maximum pore size of eight tetrahedral atoms are, for instance, ACO, AEI, AEN, AFN, AFT, AFX, ANA, APC, APD, ATT, BIK, CDO, CHA, DDR, DFT, EAB, EDI, EPI, ERI, ESV, ETL, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON and mixtures and intergrowths thereof.

In a preferred embodiment of the present invention, the crystalline small-pore aluminosilicate zeolites have maximum pore size of eight tetrahedral atoms and are chosen from AEI, AFT, AFX, CHA, DDR, ERI, ESV, ETL, KFI, LEV, UFI and mixtures and intergrowths thereof. In a more preferred embodiment, the zeolites are chosen from AEI, CHA, AFX and LEV. Even more preferred, the zeolites are chosen from AEI and CHA and mixtures and intergrowths that contain at least one of these framework types. In a particularly preferred embodiment, the zeolite is AEI. In another particularly preferred embodiment, the zeolite is CHA.

An “intergrowth” of a zeolite comprises at least two different zeolite framework types or two different zeolite compositions of the same framework type.

In an “overgrowth” zeolite, one framework structure grows on top of the other one. Thus, “overgrowth” represents a species of “intergrowth”, and “intergrowth” is the genus.

Hereinafter, the “crystalline aluminosilicate small-pore zeolites having a maximum pore size of eight tetrahedral atoms” and “the crystalline aluminosilicate small-pore zeolite having a maximum pore size of eight tetrahedral atoms” will be referred to as “the crystalline aluminosilicate zeolites” and “the crystalline aluminosilicate zeolite”.

If the crystalline aluminosilicate zeolite has the CHA framework type, this comprises all zeotypes having the CHA framework type, provided that they are crystalline aluminosilicates. Such zeotypes are, for example, SSZ-13, LZ-218, Linde D, Linde R, Phi, ZK-14, with SSZ-13 being preferred.

If the crystalline aluminosilicate zeolite has the AEI framework type, this comprises all zeotypes having the AEI framework type, provided that they are crystalline aluminosilicates. Such zeotypes are, for instance, SSZ-39 and SIZ-8.

If the crystalline aluminosilicate zeolite has the AFX framework type, this comprises all zeotypes having the AFX framework type, provided that they are crystalline aluminosilicates. Such a zeotype is, for instance, SSZ-16.

If the crystalline aluminosilicate zeolite has the LEV framework type, this comprises all zeotypes having the LEV framework type, provided that they are crystalline aluminosilicates. Such zeotypes are, for instance, ZK-20, LZ-132 and Nu-3.

The crystalline aluminosilicate zeolite has a SAR value of 5 to 50, preferably 7 to 30, more preferably 8 to 25.

The crystalline aluminosilicate zeolite comprises copper, and the copper to aluminum atomic ratio; Cu:Al, is between 0.12 and 0.55, preferably between 0.15 and 0.50 more preferably between 0.18 and 0.45.

The crystalline aluminosilicate zeolite comprises a metal M1 with a molar ratio of metal M1 to copper, M1:Cu, of between 0.05 to 0.95, preferably between 0.10 to 0.90, more preferably between 0.20 to 0.80.

The crystalline aluminosilicate comprises a metal M2 with a molar ratio of metal M2 to copper; M2:Cu, of between 0.05 to 0.80, preferably between 0.10 to 0.70, more preferably between 0.15 to 0.60.

The sum of the atomic ratios of copper, the metal M1 and the metal M2 to aluminum in the crystalline aluminosilicate zeolite, (Cu+M1+M2):Al, is between 0.20 and 1.00, preferably between 0.30 and 0.80, more preferably between 0.35 to 0.70.

The crystalline aluminosilicate zeolite comprises at least 2.50 wt.-% of copper, calculated as CuO and based on the total weight of the zeolite. Preferably, the zeolite comprises 2.5 to 8.0 wt.-% of copper, more preferably 2.5 to 7.5 wt.-%, even more preferably 3.0 to 7.2 wt.-%, and most preferably 3.0 to 6.0 wt.-% of copper, calculated as CuO and based on the total weight of the zeolite. The M1:Cu, M2:Cu and (Cu+M1+M2):Al atomic ratios as given above apply to these ranges of wt.-% of copper.

The metal M1 is calcium, magnesium or strontium, and mixtures thereof, preferably calcium or magnesium.

The metal M2 is selected from magnesium, calcium, barium, strontium, yttrium, titanium, zirconium, niobium, iron, zinc, silver, lanthanum, cerium, praseodymium, neodymium, promethium, samarium, europium, gadolinium, terbium, dysprosium, holmium, erbium, thulium, ytterbium, lutetium and mixtures thereof.

The metals M1 and M2 are different from one another. This means that M1 and M2 must not both be calcium or both be magnesium or both be strontium at the same time. It is, however, possible that M1 and M2 both represent alkaline earth metals, for example M1 is calcium and M2 is magnesium or vice versa, as long as M1 and M2 do not represent the same alkaline earth metal.

In a preferred embodiment, M1 is calcium or magnesium, and M2 is selected from iron, cerium, zirconium, yttrium, samarium, strontium, lanthanum or barium, with the amounts of the respective metals as given above. More preferably, M1 is calcium, and M2 is selected from iron, cerium, zirconium, yttrium, samarium, strontium, lanthanum and mixtures thereof.

The “total weight of the zeolite” is the sum of the weights of the white zeolite and the weights of copper, metal M1 and metal M2, wherein the weights of copper, the metal M1 and the metal M2 are calculated as the respective oxides. A “white zeolite” is a zeolite consisting of TO₄ tetrahedra which does not comprise copper, metal M1 or metal M2. Such a zeolite is colourless, also referred to as “white”, due to the absence of transition metals, which provide zeolites with a colour, for example blue in the case of a copper loading or red in the case of an iron loading, or mixed colours in case of more than one transition metal, such as copper and iron, is present. The skilled person knows that “white zeolites” usually comprise protons and alkali metal cations, albeit often in trace amounts. However, protons and alkali metals do not provide the zeolite with a colour. The term “white zeolite” therefore also includes zeolites comprising protons and alkali metal cations.

The amounts of copper and the metals M1 and M2 can be measured by ICP-AES (inductively coupled plasma atomic emission spectroscopy) or XRF (X-ray fluorescence spectroscopy). The skilled person knows how to perform such analyses and can apply this knowledge to the zeolites according to the present invention without departing from the scope of the claims.

Aluminosilicate chabazites and zeotypes thereof are commercially available. Methods for making chabazites are, for example, discloses in EP 2 931 406 B1, US 2018/079650 A1, WO 2017/080722 A1, US 2018/127282 A1 and WO 2018/189177 A1. In general, the synthesis of aluminosilicate zeolites comprises mixing a source of silicon, a source of aluminum, an alkali or alkaline earth metal hydroxide, water and at least one organic structure-directing agent (OSDA), and optionally a salt, for example a copper or iron salt. The mixture forms a gel, which is aged, heat-treated, purified and optionally calcined. The skilled person knows how to synthesize aluminosilicate chabazites and zeotypes thereof. It is also known that some methods for making aluminosilicate zeolites, in particular CHA, make use of OSDAs which are complexes of copper and an organic polyamine, for example copper tetraethylene pentaamine (Cu-TEPA). If such a complex of copper and an organic polyamine is used, the zeolite obtained thereof already comprises copper. The same applies, mutatis mutandis, if the synthesis gel comprises a salt of copper or iron: in such cases, the zeolite obtained by the synthesis already contains copper or iron. In other cases, however, the synthesis gel does not comprise copper or iron.

In the context of the present invention, the amounts of copper, M1 and M2 can be adjusted according to the respective amounts of the metals Cu, M1 and M2 in the final zeolite as indicated above by ion exchange methods. “Adjusted” means that Cu, M1 and M2 can be introduced for the first time if they are not present in the zeolite as synthesized, or their amounts can be increased or decreased if they have been introduced during the synthesis, but their amount is outside the ranges as required for the crystalline aluminosilicates according to the present invention. Increasing or decreasing the amount of the metals is particularly relevant for copper and iron if they have been introduced by the synthesis method.

As mentioned above, it is well known that metal cations can be removed from or introduced into a zeolite via ion exchange reactions. These ion exchange reactions are exemplarily described hereinafter for the introduction or removal of copper cations. The skilled person knows how to adapt these ion exchange reactions to obtain a zeolite according to the present invention with a desired content of copper, M1 and M2. The reactions described also include steps wherein metal cations are removed via the introduction of ammonium cations, followed by thermal decomposition thereof during calcination.

Copper, for instance, can be introduced via ion exchange. In a first step, an ammonium exchange is performed in order to remove alkali or alkaline earth metal cations from the zeolite framework by replacing them with NH₄⁺ cations. In a second step, NH₄⁺ is replaced by copper cations. The copper content of the resulting copper-containing zeolite can be easily controlled via the amount of copper salt and the number of ion exchange procedures performed. The copper content can be measured by ICP-AES or XRF as mentioned above.

Copper and iron can also be removed by liquid ion exchange with NH₄⁺ cations.

Methods for introducing ammonium, copper and iron cations and for removing copper and iron cations, respectively, are well known to the skilled artisan. They can be applied to the zeolites according to the present invention without departing from the scope of the claims. For example, ammonium cations can be easily introduced via liquid ion exchange, and copper cations can also easily be introduced via liquid ion exchange, incipient wetness impregnation or solid state ion exchange.

Said methods are presented exemplarily hereinafter for the introduction of copper cations. These methods are applicable to obtain zeolites according to the present invention which are loaded with copper, metal M1 and metal M2.

### Liquid Ion Exchange

An NH₄⁺ liquid ion exchange can be performed by treating the zeolite with an aqueous solution of an ammonium salt, for example NH₄Cl or NH₄NO₃.

A Cu²⁺ liquid ion exchange can be performed by treating the zeolite with an aqueous solution of a copper salt, for example copper acetate (Cu(Ac)₂), copper nitrate (Cu(NO₃)₂), copper acetylacetonate (Cu(acac)₂) or copper chloride (CuCl₂). This procedure can be repeated multiple times in order to achieve the desired copper content.

It is obvious for the skilled person that the copper to zeolite ratio in liquid ion exchange can be adjusted according to the desired copper content of the final zeolite. Generally spoken, aqueous solutions with higher copper contents yield higher copper-containing zeolites. Which copper concentration should be chosen and how often the procedure shall be repeated can easily be determined by the skilled person without departing from the scope of the claims.

Optionally, the ammonium-exchanged zeolite can be subjected to heat treatment in order to partially or completely remove the ammonium ions. Subsequently, the copper exchange can be carried out as described above.

### Incipient Wetness Impregnation

An aqueous solution of a copper salt, for example copper acetate (Cu(Ac)₂), copper nitrate (Cu(NO₃)₂) or copper chloride (CuCl₂) is dissolved in an adequate volume of water. The amount of the copper salt is equal to the amount of copper preferred in the zeolite. The incipient wetness impregnation is carried out at room temperature. Afterwards, the copper-exchanged zeolite is dried at temperatures between 6° and 70° C. for 8 to 16 hours, and the mixture is subsequently heated to temperatures in the range of 550 to 900° C.

### Solid State Ion Exchange

Suitable copper salts are, for instance, copper acetate (Cu(CH₃COO)₂), copper nitrate (Cu(NO₃)₂), copper chloride (CuCl₂), copper(II) sulfate (CuSO₄), copper(II) oxide (CuO), copper(I) oxide (Cu₂O) and copper acetylacetonate (Cu(acac)₂. The copper salt and the zeolite are mixed in a dry state, and the mixture is subsequently heated to temperatures in the range of 550 to 900° C. A process for producing metal-comprising zeolites is, for instance, disclosed in US 2013/0251611 A1. This process may be applied to the zeolites of the present invention without departing from the scope of the claims.

The ion exchange methods which are exemplarily described above for exchanging copper and ammonium ions can be applied for the exchange of the metals M1 and M2 as well. It is well known that the introduction of different metal ions, e.g. of copper ions and ions of the metals M1 and M2, can be carried out sequentially or by co-ion exchange. A sequential ion exchange means that the different cations are introduced one after the other, for example by introducing copper in the first step, metal M1 in the second and metal M2 in the third step. A co-ion exchange means that all cations, for example copper and the metals M1 and M2, are exchanged together in one step. Sequential and co-ion exchange can also be applied if more than two different cations shall be exchanged. The skilled person knows how to apply the ion exchange methods, which are exemplarily described above for the exchange of copper and ammonium ions, to the exchange of other ions, and he can apply this knowledge to the present invention without departing from the scope of the claims.

Suitable magnesium salts for introducing magnesium via ion exchange are, for example, magnesium chloride (MgCl₂), magnesium nitrate (Mg(NO₃)₂), magnesium sulfate (MgSO₄), magnesium acetate (Mg(CH₃COO)₂) and magnesium acetylacetonate (Mg(acac)₂).

Suitable calcium salts for introducing calcium via ion exchange are, for example, calcium chloride (CaCl₂), calcium nitrate (CaNO₃), calcium acetate (Ca(CH₃COO)₂) and calcium acetylacetonate (Ca(acac)₂).

Suitable barium salts for introducing barium via ion exchange are, for example, barium chloride (BaCl₂), barium nitrate (Ba(NO₃)₂), barium acetate (Ba(CH₃COO)₂) and barium acetylacetonate (Ba(acac)₂).

Suitable strontium salts for introducing strontium via ion exchange are, for example, strontium chloride (SrCl₂), strontium nitrate (Sr(NO₃)₂), strontium acetate (Sr(CH₃COO)₂) and strontium acetylacetonate (Sr(acac)₂).

Suitable yttrium salts for introducing yttrium via ion exchange are, for example, yttrium chloride (YCl₃), yttrium nitrate (Y(NO₃)₃), yttrium sulfate (Y₂(SO₄)₃), yttrium acetate (Y(CH₃COO)3) and yttrium acetylacetonate (Y(acac)₃).

Suitable titanium salts for introducing titanium via ion exchange are, for example, tetrabutyl orthotitanate (Ti(O(CH₂)₃(CH₃))₄) and ammonium hexafluortitanate ((NH₄)₂TiF₆).

Suitable zirconium salts for introducing zirconium via ion exchange are, for example, zirconium(II) chloride (ZrCl₂), zirconium(III) chloride (ZrCl₃), zirconium(IV) chloride (ZrCl₄), zirconium(II) nitrate (Zr(NO₃)₂), zirconium(IV) nitrate (Zr(NO₃)₄), zirconium(IV) sulfate (Zr(SO₄)₂) and zirconyl chloride (ZrOCl₂).

Suitable niobium salts for introducing niobium via ion exchange are, for example, niobium(IV) chloride (NbCl₄), niobium(V) chloride (Nb₂Cl₁₀), niobium oxalate (Nb(COOCOOH)₅) and niobium(V) oxychloride (NbOCl₃).

Suitable salts for introducing iron via ion exchange can be Fe²⁺ or Fe³⁺ salts such as iron(III) chloride (FeCl₃), iron(II) sulfate (FeSO₄), iron(III) sulfate (Fe₂(SO₄)₃), iron(III) nitrate (Fe(NO₃)₃), iron(II) acetate (Fe(CH₃COO)₂), iron(III) acetylacetonate (Fe(acac)₃) and iron(II) fumarate (Fe(COO(CH)₂(COO)₂).

Suitable zinc salts for introducing zinc via ion exchange are, for example, zinc acetate (Zn(CH₃COO)₂), zinc acetylacetonate (Zn(acac)₂), zinc chloride (ZnCl₂), zinc nitrate (Zn(NO₃)₂) and zinc sulfate (ZnSO₄).

Suitable silver salts for introducing silver via ion exchange are, for example, silver nitrate (AgNO₃), silver acetate (Ag(CH₃COO), silver acetylacetonate (Ag(acac)), silver oxide (Ag₂O) and silver carbonate (Ag₂CO₃).

Suitable lanthanum salts for introducing lanthanum via ion exchange are, for example, lanthanum carbonate (La₂CO₃)₃), lanthanum chloride (LaCl₃), lanthanum nitrate (La(NO₃)₃), lanthanum acetate (La(CH₃COO)₃) and lanthanum acetylacetonate (La(acac)₃).

Suitable cerium salts for introducing cerium via ion exchange are, for example, cerium(III) chloride (CeCl₃), cerium(III) sulfate (Ce₂SO₄)₃), cerium(IV) sulfate (Ce(SO₄)₂), cerium(III) nitrate (Ce(NO₃)₃), cerium(III) acetate (Ce(CH₃COO)₃) and cerium(III) acetylacetonate (Ce(acac)₃).

Suitable salts of praseodymium, neodymium, gadolinium, terbium, dysprosium, holmium, erbium, thulium, ytterbium and lutetium are the chlorides, sulfates, nitrates, acetates and acetylacetonates of the trivalent cations of Pr, Nd, Gd, Tb, Dy, Ho, Er, Tm, Yb and Lu.

Suitable promethium salts for introducing promethium via ion exchange are, for example, promethium(III) chloride (PmCl₃) and promethium(III) nitrate (Pm(NO₃)₃), Suitable samarium salts for introducing samarium via ion exchange are, for example, samarium(III) chloride (SmCl₃), samarium(III) acetate (Sm(CH₃COO)₃, samarium(III) carbonate (Sm₂(CO₃)₃), samarium(III) nitrate (Sm(NO₃)₃)), samarium(III) oxide (Sm₂O₃), samarium(III) sulfate (Sm₂(SO₄)₃) and samarium(III) acetylacetonate (Sm(acac)₃).

Suitable europium salts for introducing europium via ion exchange are, for example, europium(II) chloride (EuCl₂), europium(III) chloride (EuCl₃), europium(III) nitrate (Eu(NO₃)₃), europium(III) acetate (Eu(CH₃COO)₃) and europium(II) acetylacetonate (Eu(acac)₃).

The crystalline aluminosilicate small-pore zeolites according to the present invention can be used in a process for the removal of NOₓ from combustion exhaust gases. In this process, also known as SCR (selective catalytic reduction), these zeolites are used as the catalytically active compositions for the conversion of NOₓ. Therefore, the use of the zeolites according to the present invention as the catalytically active composition for the conversion of NOx is applicable in exhaust purification systems of mobile and stationary combustion engines. Mobile combustion engines are, for example, gasoline and diesel engines and also hydrogen internal combustion engines (H₂ ICE). The skilled person knows that combustion processes usually take place under oxidizing conditions, and that either fuels comprises nitrogen or nitrogen compounds, which can be oxidized to NOₓ, and/or that the combustion takes place in the presence of air, wherein the oxygen which is present in the air acts as the oxidant, and at least a part of the nitrogen which is present in can be oxidized to NOₓ.

Mobile combustion engines can be engines for on-road and off-road applications, for example, gasoline and diesel engines and also hydrogen internal combustion engines for passenger cars, agricultural machinery like agricultural and forestry tractors and harvesting machines, construction wheel loaders, bulldozers, highway excavators, forklift trucks, road maintenance equipment, snow plows, ground support equipment in airports, aerial lifts and mobile cranes.

Stationary combustion engines are, for example, power stations, industrial heaters, cogeneration plants including wood-fired boilers, stationary diesel and gasoline engines, industrial and municipal waste incinerators, industrial drilling rigs, compressors, manufacturing plants for glass, steel and cement, manufacturing plants for nitrogen-containing fertilizers, nitric acid production plants (for example plants applying the Ostwald process) and ammonia burners for fueling gas turbines of nitric acid production.

In a preferred embodiment, the crystalline aluminosilicate small-pore zeolites according to the present invention can be used in a process for the removal of NOₓ from automotive combustion exhaust gases, said exhaust gases deriving from diesel or gasoline engines.

The object of providing devices for the treatment of exhaust gases of combustion engines is solved by catalysed substrate monoliths comprising an SCR catalytically active composition for the conversion of NOₓ for use in treating automotive combustion exhaust gases, wherein said SCR catalytically active composition for the conversion of NOₓ is a crystalline aluminosilicate zeolite according to the present invention.

In some embodiments of the SCR catalytically active compositions according to the present invention, said SCR catalytically active composition is present in the form of a coating on a carrier substrate, i.e. as a washcoat on a carrier substrate. Carrier substrates can be so-called honeycomb flow-through substrates and wall-flow filters as well as corrugated substrates, wound or packed fiber filters, open cell foams and sintered metal filters. In a preferred embodiment, the carrier substrate is a honeycomb flow-through substrate or a honeycomb wall-flow filter.

Flow-through substrates and wall-flow filters may consist of inert materials, such as silicon carbide, aluminum titanate, cordierite, metal or metal alloys. Such carrier substrates are well-known to the skilled person and available on the market. Corrugated substrates are made of ceramic E-glass fiber paper or of metal or metal alloys. They are also well known to the skilled person and available on the market.

When the SCR catalytically active composition is present in the form of a coating on a carrier substrate, it is typically present on or in the substrate in amounts from about 10 to about 600 g/L, preferably about 100 to about 300 g/L, as calculated by the weight of the molecular sieve per volume of the total catalyst article.

The SCR catalytically active composition can be coated on or into the substrate using known wash-coating techniques. In this approach the molecular sieve powder is suspended in a liquid medium together with binder(s) and stabilizer(s). The wash coat can then be applied onto the surfaces and walls of the substrate. The washcoat optionally also contains binders based on TiO₂, SiO₂, Al₂O₃, ZrO₂, CeO₂ and combinations thereof.

The washcoat may furthermore optionally comprise an additive. The additive may be present together with a binder, as mentioned above, or the washcoat may comprise only a binder or only an additive. Suitable additives are polysaccharides, polyvinylalcohols, glycerol; linear or branched-chain poly-functionalized organic molecules having two or more carbon atoms in the chain, with up to about 12 carbon atoms (Cₙ; wherein 2≤n≤12); salts of basic quaternary amines, wherein one or more quaternary amine groups are attached to four carbon chains having length of Cₙ, where 1≤n≤5 and wherein the cation is balanced as a salt using, but not limited to, one of the following anions: hydroxide, fluoride, chloride, bromide, iodide, carbonate, sulfate, sulfite, oxalate, maleate, phosphate, aluminate, silicate, borate, or other suitable organic or inorganic counter ions; inorganic bases taken from, but not limited to the following list: lithium hydroxide, sodium hydroxide, potassium hydroxide, magnesium hydroxide, calcium hydroxide, strontium hydroxide, and barium hydroxide; and, simple salts of transition or rare earth elements, including, but not limited to the following: nitrates, carbonates, sulfates, phosphates, borates of rare earth elements from atomic number 57 (La) to 71 (Lu) and including Sc, Y, Ti, Zr, and Hf, as mentioned above.

In a preferred embodiment, the additive is a polysaccharide selected from the group consisting of a galactomannan gum, xanthan gum, guar gum curdlan, Schizophyllan, Scleroglucan, Diutan gum, Welan gum, a starch, a cellulose or an alginate or is derived from a starch, a cellulose (i.e. cellulosic) or an alginate, and mixtures of thereof. Cellulosic additives may be selected from the group consisting of carboxymethyl cellulose, hydroxymethyl cellulose, hydroxyethyl cellulose, methyl cellulose, methyl hydroxyethyl cellulose, methyl hydroxypropyl cellulose and ethyl hydroxyethyl cellulose.

More preferably, the additive is xanthan gum, guar gum or a mixture thereof. Even more preferably the additive is xanthan gum.

In case the first and/or the second washcoat comprise an additive, said additive is present in an amount of up to 20 wt.-%, preferably 3 to 15 wt.-%, more preferably 6 to 10 wt.-%, based on the total weight of the oxides, wherein the “total weight of the oxides” is the sum of weights of the zeolite and the binder. It will be understood that, if the washcoat does not comprise a binder, the “total weight of the oxides” corresponds to the weight of the zeolite.

In other embodiments, the carrier substrates may be catalytically active on their own, and they may further comprise catalytically active compositions, i.e. a crystalline aluminosilicate zeolites according to the present invention. In addition to the catalytically active composition, these carrier substrates comprise a matrix component. All inert materials which are otherwise used for the manufacturing of catalyst substrates may be used as matrix components in this context. It deals, for instance, with silicates, oxides, nitrides or carbides, with magnesium aluminum silicates being particularly preferred.

In other embodiments of the SCR catalytically active compositions according to the present invention, the catalyst itself forms part of the carrier substrate, for example as part of a flow-through substrate or a wall-flow filter. Such carrier substrates additionally comprise the matrix components described above.

Carrier substrates comprising the SCR catalytically active compositions according to the present invention may be used as such in exhaust purification. Alternatively, they may be coated with catalytically active compositions, for example with SCR-catalytically active compositions. Insofar as these materials shall exhibit an SCR catalytic activity, the SCR catalytically active compositions mentioned above are suitable materials.

In one embodiment, catalytically active carrier materials are manufactured by mixing 10 to 95 wt.-% of at least one inert matrix component and 5 to 90 wt.-% of a catalytically active composition, followed by extruding the mixture according to well-known protocols. As already described above, inert materials that are usually used for the manufacture of catalyst substrates may be used as the matrix components in this embodiment. Suitable inert matrix materials are, for example, silicates, oxides, nitrides and carbides, with magnesium aluminum silicates being particularly preferred. Catalytically active carrier materials obtainable by such processes are known as “extruded catalysed substrate monoliths”. In the context of the present invention, an “extruded catalysed substrate monolith” is an extruded monolith wherein the catalytically active composition is a crystalline aluminosilicate zeolite having a maximum ring size of eight tetrahedral atoms, said zeolite comprising copper, metal M1 and metal M2 as described above.

The application of the catalytically active components onto either the inert carrier substrate or onto a carrier substrate which is catalytically active on its own as well as the application of a catalytically active coating onto a carrier substrate, said carrier substrate comprising a catalyst according to the present invention, can be carried out following manufacturing processes well known to the person skilled in the art, for instance by widely used dip coating, pump coating and suction coating, followed by subsequent thermal post-treatment (calcination).

The skilled person knows that in the case of wall-flow filters, their average pore sizes and the mean particle size of the catalytically active components according to the present invention may be adjusted to one another in a manner that the coating thus obtained is located onto the porous walls which form the channels of the wall-flow filter (on-wall coating). However, the average pore sizes and the mean particle sizes are preferably adjusted to one another in a manner that the catalyst according to the present invention is located within the porous walls which form the channels of the wall-flow filter. In this preferable embodiment, the inner surfaces of the pores are coated (in-wall coating). In this case, the mean particle size of the catalysts according to the present invention has to be sufficiently small to be able to penetrate the pores of the wall-flow filter. Wall-flow filters which are coated with an SCR catalytically active compositions are also known as “SDPF” (SCR on DPF, i.e. an SCR catalytically active composition coated onto a diesel particulate filter) or as “SCRF” (SCR on filter). Thus, the present invention encompasses catalysed substrate monoliths wherein the monolith is a wall-flow filter, and the SCR catalytically compositions comprises a crystalline aluminosilicate zeolite according to the present invention.

Furthermore, the present invention encompasses ammonia slip catalysts (ASC). It is well known to the skilled person that in exhaust gas purification systems, an ASC is preferably located downstream of the SCR, because recognizable amounts of NH₃ leave the SCR due to the dynamic driving conditions. Therefore, the conversion of excess ammonia which leaves the SCR is mandatory, since ammonia is also an emission regulated gas. Oxidation of ammonia leads to the formation of NO as main product, which would consequently contribute negatively to the total conversion of NOₓ of the whole exhaust system. An ASC may thus be located downstream the SCR to mitigate the emission of additional NO. The ASC catalyst combines the key NH₃ oxidation function with an SCR function. Ammonia entering the ASC is partially oxidized to NO. The freshly oxidized NO and NH₃ inside the ASC, not yet oxidized, can consequently react to N₂ following the usual SCR reaction schemes. In doing so, the ASC is capable of eliminating the traces of ammonia by converting them in a parallel mechanism to N₂.

It will be understood by the skilled person that the SCR catalyst and the ASC catalyst may be present as two consecutive catalytic articles, or the SCR functionality and the ASC functionality may be present on one single catalytic article. In case of two consecutive catalytic articles, the upstream catalytic article is the SCR catalyst comprising a carrier substrate and a washcoat comprising an SCR catalytically active composition, and the downstream catalytic article is the ASC catalyst comprising a carrier substrate, a washcoat comprising an oxidation catalyst, and a washcoat comprising an SCR catalytically active composition. In case the SCR catalyst and the ASC catalyst are present on one single substrate, a washcoat comprising an SCR catalytically active composition, but no oxidation catalyst is coated onto the upstream zone of the carrier substrate, and the downstream zone of said carrier substrate contains a bottom layer with a washcoat comprising an oxidation catalyst and a top layer with a washcoat comprising an SCR catalytically active composition. In all the embodiments wherein an SCR catalyst is combined with a downstream ASC catalyst, the SCR catalytically active composition of the SCR catalyst is preferably a crystalline aluminosilicate zeolite according to the present invention. The SCR catalytically active composition of the ASC can be selected from crystalline aluminosilicate zeolites according to the present invention, other zeolitic and non-zeolitic molecular sieves as described above, and mixed oxides comprising vanadia and titania. In case other zeolitic and non-zeolitic molecular sieves are used, they are preferably loaded with a least one transition metal, preferably copper and/or iron. In case a mixed oxide comprising vanadia and titania is used, it may optionally also comprise oxides of one or more elements selected from tungsten, silicon, aluminum, zirconium, molybdenum, niobium and antimony.

Platinum group metals are used as oxidation catalysts in an ASC, and zeolites may be used for the SCR function. The precious metal is a platinum group metal selected from ruthenium, rhodium, palladium, osmium, iridium, platinum and mixtures thereof. Preferably, the precious metal is chosen from palladium, platinum, rhodium and mixtures thereof, more preferably, the precious metal is platinum. In a preferred embodiment, the platinum group metal is added in the form of a precursor salt to a washcoat slurry and applied to the carrier monolith. The platinum group metal is present in a concentration of 0.01 to 10 wt.-%, preferably 0.05 to 5 wt.-%, even more preferably 0.1 to 3 wt.-%, calculated as the respective platinum group metal and based on the total weight of the washcoat loading. In a preferred embodiment, the platinum group metal is platinum, and it is present in a concentration of 0.1 to 1 wt.-%, calculated as Pt and based on the total weight of washcoat loading.

In one embodiment, the ASC catalyst is a catalysed substrate monolith, wherein the monolith is a flow-through monolith coated with a bottom layer comprising an oxidation catalyst and a top layer comprising a crystalline aluminosilicate zeolite according to the present invention.

In all devices for the treatment of exhaust gases of combustion engines comprising a crystalline aluminosilicate zeolite according to the present invention as the SCR catalytically active composition, it is possible to use one or more of these SCR catalytically active compositions. If more than one of the SCR catalytically active compositions are present, they can be present in the form of two or more different layers, two or more different zones, as a mixture of two or more different SCR catalytically active compositions within one washcoat. Furthermore, the layers or zone may, independently from one another, comprises one single SCR catalytically active composition or a mixture of two or more of SCR catalytically active compositions. Two or more crystalline aluminosilicate zeolites according to the present invention are “different” if they differ in at least one parameter selected from the framework type, the SAR value, the copper content and/or the content of the metal M1 and/or the content of the metal M2.

The present invention furthermore provides an emissions treatment system for the removal of NOx emissions from exhaust gases of internal combustion engines, and optionally also for the removal of particulate matter, the system comprising, in the following order, from upstream to downstream:
a) means for injecting ammonia or an ammonia precursor solution into the exhaust gas stream,
b) a catalysed substrate monolith comprising an SCR-catalytically active composition for the conversion of NOx in automotive combustion exhaust gases, wherein said SCR catalytically active compositions for the conversion of NOx is a crystalline aluminosilicate zeolite according to the present invention, and wherein the substrate monolith is selected from honeycomb flow-through substrates, honeycomb wall-flow filters, corrugated substrates, wound or packed fiber filters, open cell foams, sintered metal filters and extruded catalysed substrate monoliths.

It will be understood by the skilled person that in case the substrate monolith is a flow-through monolith or a corrugated substrate, the corresponding catalysed substrate monolith will remove NOx emissions only. If, however, the substrate monolith is a wall-flow filter, the corresponding catalysed substrate monolith will also remove particulate matter. The skilled person knows that the SCR reaction requires the presence of ammonia as a reductant. Ammonia may be supplied in an appropriate form, for instance in the form of liquid ammonia or in the form of an aqueous solution of an ammonia precursor, and added to the exhaust gas stream as needed via means for injecting ammonia or an ammonia precursor. Suitable ammonia precursors are, for instance urea, ammonium carbamate or ammonium formate. Alternatively, the ammonia may be formed by catalytic reactions within the exhaust gas.

A widespread method is to carry along an aqueous urea solution and to and to dose it into the catalyst according to the present invention via an upstream injector and a dosing unit as required. Means for injecting ammonia, for example an upstream injector and a dosing unit, are well known to the skilled person and can be used in the present invention without departing from the scope of the claims.

It will furthermore be understood that an emissions treatment system for the removal of NOₓ emissions from exhaust gases of internal combustion engines, and optionally also for the removal of particulate matter, the system comprising a catalysed substrate monolith comprising an SCR-catalytically active composition for the conversion of NOₓ in automotive combustion exhaust gases, wherein said SCR catalytically active compositions for the conversion of NOₓ is a crystalline aluminosilicate zeolite according to the present invention, may comprise additional catalytic articles, for instance a diesel oxidation catalyst (DOC), an ammonia slip catalyst (ASC), a catalysed or uncatalysed particulate filter, a passive NOₓ adsorber (PNA), and/or a lean NOₓ trap (LNT). A catalysed particulate filter may be coated with a diesel oxidation catalyst, thus forming a “catalysed diesel particulate filter (CDPF), or it may be coated with an SCR catalytically active composition, thus forming an SDPF.

In one embodiment of the present invention, the emissions treatment system comprising a catalysed substrate monolith comprising an SCR-catalytically active composition according to the present invention is arranged in a close-coupled position. The term “close-coupled” refers to a position of a catalytic device in an engine's exhaust gas treatment system which is less than 1 meter downstream of the engine's exhaust gas manifold or turbocharger. In a preferred embodiment, the emissions treatment system comprising a catalysed substrate monolith comprising an SCR-catalytically active composition according to the present invention furthermore comprises one or more particulate filters. In this embodiment, the “first” filter is the filter that is arranged closest to the engine. The “second” filter, if present, is located downstream of the first filter, either directly following the first filter, or in a position further downstream. In this embodiment, the catalysed substrate monolith comprising an SCR-catalytically active composition according to the present invention, which is arranged in a close-coupled position, is arranged upstream of the first filter.

As mentioned above, the catalysed substrate monolith comprising an SCR-catalytically active composition according to the present invention can be a honeycomb flow-through substrate, a honeycomb wall-flow filter, a corrugated substrate, a wound or packed fiber filter, an open cell foam or a sintered metal filter. Preferably, it is a honeycomb flow-through substrate or a honeycomb wall-flow filter. If the catalysed substrate monolith is a honeycomb wall-flow filter comprising an SCR-catalytically active composition according to the present invention, it deals with an SDPF.

In yet another embodiment of the present invention, the emissions treatment system is arranged in an underfloor position. Underfloor catalyst members are also known in the prior art and are located downstream of any close-coupled and/or medium-coupled catalysts under the floor of the vehicle adjacent to or in combination with the vehicle's muffler. In this embodiment, the catalysed substrate monolith comprising an SCR-catalytically active composition according to the present invention is arranged downstream the first filter. The substrates of the catalysed substrate monolith comprising an SCR-catalytically active composition according to the present invention are the same as those mentioned above for the close-coupled arrangement.

In yet another embodiment of the present invention, the emissions treatment system comprising a catalysed substrate monolith comprising an SCR-catalytically active composition according to the present invention is arranged upstream of the first particulate filter, but 1 meter or more downstream of the engine's exhaust gas manifold or turbocharger. In this embodiment, the catalysed substrate monolith comprising an SCR-catalytically active composition according to the present invention preferably is the first brick downstream of the engine's exhaust gas manifold or turbocharger.

In yet another embodiment of the present invention, the emissions treatment system comprising a catalysed substrate monolith comprising an SCR-catalytically active composition according to the present invention is arranged downstream of the first particulate filter.

In these embodiments wherein the catalysed substrate monolith comprising an SCR-catalytically active composition according to the present invention is located either upstream or downstream of the first particulate filter, the substrate monoliths comprising an SCR-catalytically active composition according to the present invention are the same as those mentioned above for the close-coupled arrangement and the underfloor arrangement.

The present invention furthermore provides a method for the removal of NOx emissions from exhaust gases of internal combustion engines, and optionally also for the removal of particulate matter, the method comprising, in the following order, from upstream to downstream:
a) injecting ammonia or an ammonia precursor solution into the exhaust gas stream,
b) introducing the exhaust gas from step a) into a catalysed substrate monolith comprising an SCR-catalytically active composition for the conversion of NOx in automotive combustion exhaust gases, wherein said SCR catalytically active compositions for the conversion of NOx is a crystalline aluminosilicate zeolite according to the present invention, and wherein the substrate monolith is selected from honeycomb flow-through substrates, honeycomb wall-flow filters, corrugated substrates, wound or packed fiber filters, open cell foams, sintered metal filters and extruded catalysed substrate monoliths.

As mentioned above for the emissions treatment system, it will be understood by the skilled person that in case the substrate monolith used in step b) of the method above is a flow-through monolith or a corrugated substrate, the corresponding catalysed substrate monolith will remove NOx emissions only. If, however, the substrate monolith used in step b) of the method above is a wall-flow filter, the corresponding catalysed substrate monolith will also remove particulate matter.

### BRIEF DESCRIPTION OF THE DRAWINGS

FIG. 1 shows the NOₓ conversion at 175° C. and the N₂O reduction at 400° C., each in percent, for CE1, CE4, Ex1, Ex3 and Ex5 in the aged state under NO only conditions.

FIG. 2 shows the NOₓ conversion at 175° C. and the N₂O reduction at 400° C., each in percent, for CE1, Ex1, Ex3 and Ex5 in the aged state at 175° C. and 400° C. under 25% NO₂ conditions.

FIG. 3 shows the NOₓ conversion at 175° C. and the N₂O reduction at 400° C., each in percent, for CE6, CE7, Ex5, Ex6, Ex12, Ex14 and Ex15 in the aged state at 175° C. and 400° C. under 25% NO₂ conditions.

FIG. 4 shows the NOₓ conversion at 175° C. and the N₂O reduction at 400° C., each in percent, for CE8, CE9, CE10, Ex3, Ex4, Ex7, Ex8, Ex9, Ex10 and Ex16 in the aged state at 175° C. and 400° C. under 25% NO₂ conditions.

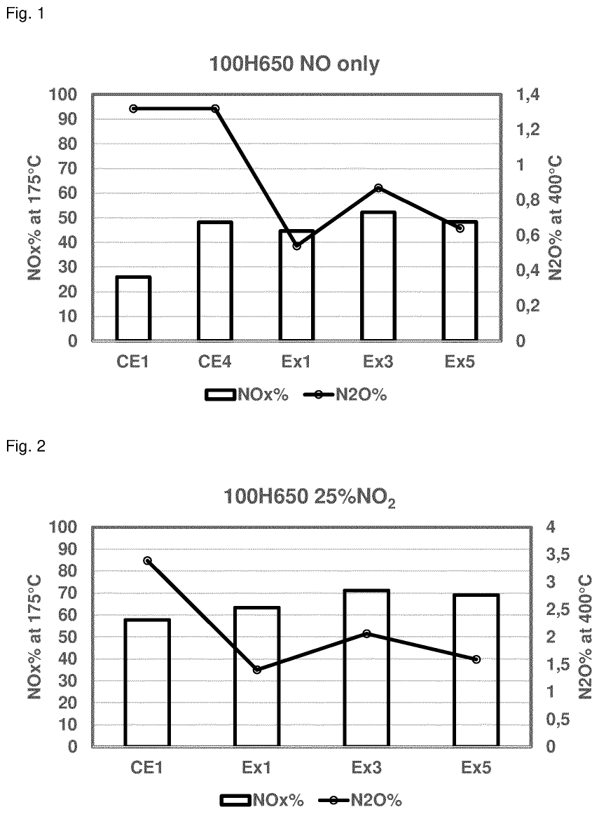

### EMBODIMENTS

### Comparative Example 1 (CE1): CuCHA

11.5 g of copper (II) acetylacetonate (24.4% by weight Cu, ex Aldrich) was coarsely mixed with 96.5 g of CHA (SAR 13.4) in a sealable plastic bottle of 250 mL capacity. Next 10 g Y-stabilised ZrO₂ beads, (5 mm diameter), were added. The bottle was sealed and locked into a paint shaker (Olbrich Model RM 500, 0.55 KW) and homogenised by vibration for 5 minutes. The bottle was then unlocked from the paint shaker and the mixture passed through a coarse sieve to remove the beads. Finally the mixed powders were transferred to a calcination vessel and heated in static air to 600° C. (at a ramp rate of 5° C./min) and for a period of 2 hours.

The CHA thus obtained had a Cu:Al molar ratio of 0.21 and a Cu content of 3.5 wt.-%, calculated as CuO and based on the total weight of the zeolite.

### Comparative Example 2 (CE2): CuCHA

20.4 g of Cu(NO₃)₂·2.5H₂O crystals were dissolved under stirring in 40 g of de-ionised water. The solution thus produced was added dropwise to 93.0 g of CHA (SAR 13.4) with constant stirring over 15 minutes. The powder obtained was further dried in air at 80° C. for 4 h following by calcination for 2 hours at 600° C. in air.

The CHA thus obtained had a Cu:Al molar ratio of 0.43 and a Cu content of 7.0 wt.-%, calculated as CuO and based on the total weight of the zeolite.

### Comparative Example 3 (CE3): CuCHA

This material was prepared following the method described in Comparative Example 1, with the exception that the mixture comprised 12.5 g of copper (II) acetylacetonate and 96.2 g of CHA (SAR 13.4).

The CHA thus obtained had a Cu:Al molar ratio of 0.23 and a Cu content of 3.8 wt.-%, calculated as CuO and based on the total weight of the zeolite.

### Comparative Example 4 (CE4): CuCaCHA

This material was prepared following the method described in Comparative Example 1, with the exception that the mixture comprised 11.5 g of copper (II) acetylacetonate, 11.3 g of Ca (II) acetylacetonate hydrate and 94.0 g of CHA (SAR 13.4).

The CHA thus obtained had a Cu:Al molar ratio of 0.21, a Cu:Ca molar ratio of 1.0, a (Cu+Ca):Al molar ratio of 0.42 and a Cu content of 3.5 wt.-%, calculated as CuO and based on the total weight of the zeolite.

### Comparative Example 5 (CE5): CuCaCHA

This material was prepared following the method described in Comparative Example 2, with the exception that the mixture comprised 21.3 g of Cu(NO₃)₂·2.5H₂O, 3.1 g of Ca(NO₃)₂·4H₂O, and 95.7 g of CHA (SAR 13.4).

The CHA thus obtained had a Cu:Al molar ratio of 0.43, a Ca:Cu molar ratio of 0.15, a (Cu+Ca):Al molar ratio of 0.49 and a Cu content of 7.0 wt.-%, calculated as CuO and based on the total weight of the zeolite.

### Comparative Example 6 (CE 6): CuCaCHA

This material was prepared following the method described in Comparative Example 2, with the exception that the mixture comprised 7.6 g of Cu(NO₃)₂·2.5H₂O, 4.2 g of Ca(NO₃)₂·4H₂O and 96.5 g of CHA (SAR 23.8).

The CHA thus obtained had a Cu:Al molar ratio of 0.25, a Ca:Al molar ratio of 0.14, and a Cu content of 2.5 wt.-%, calculated as CuO and based on the total weight of the zeolite.

### Comparative Example 7 (CE 7): CuCaCHA

This material was prepared following the method described in Comparative Example 2, with the exception that the mixture comprised 7.6 g of Cu(NO₃)₂·2.5H₂O, 6.5 g of Ca(NO₃)₂·4H₂O and 96.5 g of CHA (SAR 17.5).

The CHA thus obtained had a Cu:Al molar ratio of 0.18, a Ca:Al molar ratio of 0.16, and a Cu content of 2.5 wt.-%, calculated as CuO and based on the total weight of the zeolite.

### Comparative Example 8 (CE 8): CuFeKCHA

This material was prepared following the method described in Comparative Example 2, with the exception that the mixture comprised 9.1 g of Cu(NO₃)₂·2.5H₂O, 2.6 g of Fe(NO₃)₃·9H₂O, 0.6 g of KNO₃ and 96.2 g of CHA (SAR 13.4).

The CHA thus obtained had a Cu:Al molar ratio of 0.18, a Fe:Al molar ratio of 0.03, a (Cu+Fe):K molar ratio of 7, and a Cu content of 3.0 wt.-%, calculated as CuO and based on the total weight of the zeolite.

### Comparative Example 9 (CE 9): CuFeKCHA

This material was prepared following the method described in Comparative Example 2, with the exception that the mixture comprised 10.6 g of Cu(NO₃)₂·2.5H₂O, 1.8 g of Fe(NO₃)₃·9H₂O, 0.7 g of KNO₃ and 95.8 g of CHA (SAR 13.4).

The CHA thus obtained had a Cu:Al molar ratio of 0.21, a Fe:Al molar ratio of 0.02, a (Cu+Fe):K molar ratio of 7, and a Cu content of 3.5 wt.-%, calculated as CuO and based on the total weight of the zeolite.

### Comparative Example 10 (CE 10): CuFeNaCHA

This material was prepared following the method described in Comparative Example 2, with the exception that the mixture comprised 9.1 g of Cu(NO₃)₂·2.5H₂O, 2.6 g of Fe(NO₃)₃·9H₂O, 0.5 g of NaNO₃ and 95.8 g of CHA (SAR 13.4).

The CHA thus obtained had a Cu:Al molar ratio of 0.18, a Fe:Al molar ratio of 0.03, a (Cu+Fe):Na molar ratio of 7, and a Cu content of 3.0 wt.-%, calculated as CuO and based on the total weight of the zeolite.

### Example 1 (Ex1): CuCaBaCHA

This material was prepared following the method described in Comparative Example 1″, with the exception that the mixture comprised 11.5 g of copper (II) acetylacetonate, 5.6 g of Ca (II) acetylacetonate, 7.8 g of Ba (II) acetylacetonate, and 93.6 g of CHA (SAR 13.4).

The CHA thus obtained had a Cu:Al molar ratio of 0.21, a Ca:Cu molar ratio of 0.50, a Ba:Cu molar ratio of 0.50, a (Cu+Ca+Ba):Al molar ratio of 0.42 and a Cu content of 3.5 wt.-%, calculated as CuO and based on the total weight of the zeolite.

### Example 2 (Ex2): CuCaBaCHA

This material was prepared following the method described in Comparative Example 1″, with the exception that the mixture comprised 11.5 g of copper (II) acetylacetonate, 3.4 g of Ca (II) acetylacetonate, 4.7 g of Ba (II) acetylacetonate, and 93.7 g of CHA (SAR 13.4).

The CHA thus obtained had a Cu:Al molar ratio of 0.21, a Ca:Cu molar ratio of 0.30, a Ba:Cu molar ratio of 0.30, a (Cu+Ca+Ba):Al molar ratio of 0.34 and a Cu content of 3.5 wt.-%, calculated as CuO and based on the total weight of the zeolite.

### Example 3 (Ex3): CuCaFeCHA

This material was prepared following the method described in Comparative Example 1″, with the exception that the mixture comprised 11.5 g of copper (II) acetylacetonate, 5.6 g of Ca (II) acetylacetonate, 7.8 g of Fe (III) acetylacetonate, and 95.3 g of CHA (SAR 13.4).

The CHA thus obtained had a Cu:Al molar ratio of 0.21, a Ca:Cu molar ratio of 0.50, a Fe:Cu molar ratio of 0.50, a (Cu+Ca+Fe):Al molar ratio of 0.42 and a Cu content of 3.5 wt.-%, calculated as CuO and based on the total weight of the zeolite.

### Example 4 (Ex4): CuCaFeCHA

This material was prepared following the method described in Comparative Example 1″, with the exception that the mixture comprised 11.5 g of copper (II) acetylacetonate, 3.4 g of Ca (II) acetylacetonate, 4.6 g of Fe (III) acetylacetonate, and 94.7 g of CHA (SAR 13.4).

The CHA thus obtained had a Cu:Al molar ratio of 0.21, a Ca:Cu molar ratio of 0.30, a Fe:Cu molar ratio of 0.30, a (Cu+Ca+Fe):Al molar ratio of 0.34 and a Cu content of 3.5 wt.-%, calculated as CuO and based on the total weight of the zeolite.

### Example 5 (Ex5): CuCaSmCHA

This material was prepared following the method described in Comparative Example 1″, with the exception that the mixture comprised 11.5 g of copper (II) acetylacetonate, 5.6 g of Ca (II) acetylacetonate, 10.2 g of Sm (III) acetylacetonate, and 94.8 g of CHA (SAR 13.4).

The CHA thus obtained had a Cu:Al molar ratio of 0.21, a Ca:Cu molar ratio of 0.50, a Sm:Cu molar ratio of 0.50, a (Cu+Ca+Sm):Al molar ratio of 0.42 and a Cu content of 3.5 wt.-%, calculated as CuO and based on the total weight of the zeolite.

### Example 6 (Ex6): CuCaSmCHA

This material was prepared following the method described in Comparative Example 1″, with the exception that the mixture comprised 11.5 g of copper (II) acetylacetonate, 3.4 g of Ca (II) acetylacetonate, 6.1 g of Sm (III) acetylacetonate, and 93.4 g of CHA (SAR 13.4).

The CHA thus obtained had a Cu:Al molar ratio of 0.21, a Ca:Cu molar ratio of 0.30, a Sm:Cu molar ratio of 0.30, a (Cu+Ca+Sm):Al molar ratio of 0.34 and a Cu content of 3.5 wt.-%, calculated as CuO and based on the total weight of the zeolite.

### Example 7 (Ex7): CuCaFeCHA

This material was prepared following the method described in Comparative Example 2, with the exception that the mixture comprised 21.3 g of Cu(NO₃)₂·2.5H₂O, 5.2 g of Ca(NO₃)₂·4H₂O, 8.9 g of Fe(NO₃)₃·9H₂O, and 93.5 g of CHA (SAR 13.4).

The CHA thus obtained had a Cu:Al molar ratio of 0.43, a Ca:Cu molar ratio of 0.25, a Fe:Cu molar ratio of 0.25, a (Cu+Ca+Fe):Al molar ratio of 0.65 and a Cu content of 7.0 wt.-%, calculated as CuO and based on the total weight of the zeolite.

### Example 8 (Ex8): CuCaFeCHA

This material was prepared following the method described in Comparative Example 2, with the exception that the mixture comprised 21.3 g of Cu(NO₃)₂·2.5H₂O, 3.1 g of Ca(NO)₂·4H₂O, 5.3 g of Fe(NO₃)₃·9H₂O, and 94.7 g of CHA (SAR 13.4).

The CHA thus obtained had a Cu:Al molar ratio of 0.43, a Ca:Cu molar ratio of 0.15, a Fe:Cu molar ratio of 0.15, a (Cu+Ca+Fe):Al molar ratio of 0.56 and a Cu content of 7.0 wt.-%, calculated as CuO and based on the total weight of the zeolite.

### Example 9 (Ex9): CuCaFeCHA

This material was prepared following the method described in Comparative Example 1″, with the exception that the mixture comprised 12.5 g of copper (II) acetylacetonate, 6.1 g of Ca (II) acetylacetonate, 8.4 g of iron (III) acetylacetonate, and 91.0 g of CHA (SAR 13.4).

The CHA thus obtained had a Cu:Al molar ratio of 0.23, a Ca:Cu molar ratio of 0.50, a Fe:Cu molar ratio of 0.50, a (Cu+Ca+Fe):Al molar ratio of 0.46 and a Cu content of 3.8 wt.-%, calculated as CuO and based on the total weight of the zeolite.

### Example 10 (Ex10): CuCaFeCHA

This material was prepared following the method described in Comparative Example 1″, with the exception that the mixture comprised 12.5 g of copper (II) acetylacetonate, 8.6 g of Ca (II) acetylacetonate, 5.1 g of iron (III) acetylacetonate, and 93.2 g of CHA (SAR 13.4).

The CHA thus obtained had a Cu:Al molar ratio of 0.23, a Ca:Cu molar ratio of 0.70, a Fe:Cu molar ratio of 0.30, a (Cu+Ca+Fe):Al molar ratio of 0.46 and a Cu content of 3.8 wt.-%, calculated as CuO and based on the total weight of the zeolite.

### Example 11 (Ex11): CuSrCaCHA

This material was prepared following the method described in Comparative Example 2, with the exception that the mixture comprised 10.6 g of Cu(NO₃)₂·3H₂O, 5.2 g of Ca(NO₃)₂·4H₂O, 4.6 g of Sr(NO₃)₂, and 93.0 g of CHA (SAR 13.4).

The CHA thus obtained had a Cu:Al molar ratio of 0.21, a Ca:Cu molar ratio of 0.5, a Sr:Cu molar ratio of 0.5, a (Cu+Ca+Sr):Al molar ratio of 0.42 and a Cu content of 3.5 wt. %, calculated as CuO and based on the total weight of the zeolite.

### Example 12 (Ex12): CuCaCeCHA

This material was prepared following the method described in Comparative Example 2, with the exception that the mixture comprised 10.6 g of Cu(NO₃)₂·3H₂O, 7.3 g of Ca(NO₃)₂·4H₂O, 5.7 g of Ce(NO₃)₃·6H₂O, and 92.5 g of CHA (SAR 13.4).

The CHA thus obtained had a Cu:Al molar ratio of 0.21, a Ca:Cu molar ratio of 0.7, a Ce:Cu molar ratio of 0.3, a (Cu+Ca+Ce):Al molar ratio of 0.42 and a Cu content of 3.5 wt.-%, calculated as CuO and based on the total weight of the zeolite.

### Example 13 (Ex13): CuCaZrCHA

This material was prepared following the method described in Comparative Example 2, with the exception that the mixture comprised 10.6 g of Cu(NO₃)₂·3H₂O, 7.3 g of Ca(NO₃)₂·4H₂O, 3.3 g of ZrO(NO₃)₂, and 92.5 g of CHA (SAR 13.4).

The CHA thus obtained had a Cu:Al molar ratio of 0.21, a Ca:Cu molar ratio of 0.7, a Zr:Cu molar ratio of 0.3, a (Cu+Zr+Ce):Al molar ratio of 0.42 and a Cu content of 3.5 wt. %, calculated as CuO and based on the total weight of the zeolite.

### Example 14 (Ex14): CuCaYCHA

This material was prepared following the method described in Comparative Example 2, with the exception that the mixture comprised 10.6 g of Cu(NO₃)₂·3H₂O, 7.3 g of Ca(NO₃)₂·4H₂O, 5.1 g of Y(NO₃)₃·6H₂O, and 92.5 g of CHA (SAR 13.4).

The CHA thus obtained had a Cu:Al molar ratio of 0.21, a Ca:Cu molar ratio of 0.7, a Y:Cu molar ratio of 0.3, a (Cu+Ca+Y):Al molar ratio of 0.42 and a Cu content of 3.5 wt. %, calculated as CuO and based on the total weight of the zeolite.

### Example 15 (Ex15): CuCaLaCHA

This material was prepared following the method described in Comparative Example 2, with the exception that the mixture comprised 10.6 g of Cu(NO₃)₂·3H₂O, 7.3 g of Ca(NO₃)₂·4H₂O, 5.7 g of La(NO₃)₃·6H₂O, and 92.6 g of CHA (SAR 13.4).

The CHA thus obtained had a Cu:Al molar ratio of 0.21, a Ca:Cu molar ratio of 0.7, a La:Cu molar ratio of 0.3, a (Cu+Ca+La):Al molar ratio of 0.42 and a Cu content of 3.5 wt.-%, calculated as CuO and based on the total weight of the zeolite.

### Example 16 (Ex16): CuMgFeCHA

This material was prepared following the method described in Comparative Example 2, with the exception that the mixture comprised 10.6 g of Cu(NO₃)₂·3H₂O, 7.9 g of Mg(NO₃)₂·6H₂O, 5.3 g of Fe(NO₃)₃·9H₂O, and 92.5 g of CHA (SAR 13.4).

The CHA thus obtained had a Cu:Al molar ratio of 0.21, a Mg:Cu molar ratio of 0.7, a Fe:Cu molar ratio of 0.3, a (Cu+Mg+Fe):Al molar ratio of 0.42 and a Cu content of 3.5 wt.-%, calculated as CuO and based on the total weight of the zeolite.

### Example 17 (Ex17): CuMgCaCHA

This material was prepared following the method described in Comparative Example 2, with the exception that the mixture comprised 10.6 g of Cu(NO₃)₂·3H₂O, 5.6 g of Mg(NO₃)₂·6H₂O, 5.2 g of Ca(NO₃)₂·4H₂O, and 94.3 g of CHA (SAR 13.4).

The CHA thus obtained had a Cu:Al molar ratio of 0.21, a Mg:Cu molar ratio of 0.5, a Ca:Cu molar ratio of 0.5, a (Cu+Mg+Ca):Al molar ratio of 0.42 and a Cu content of 3.5 wt.-%, calculated as CuO and based on the total weight of the zeolite.

### Measurement of NOx Conversion and N₂O Reduction

The Comparative Examples and Examples according to the present invention, as listed above, were tested for their reaction behavior in NOₓ conversion and N₂O reduction. The Examples according to the present invention were compared with zeolites comprising copper only, or only copper and calcium as metal M1, but no metal M2. These comparative tests illustrate the low temperature performance and durability benefits of the present invention for SCR application. The measurements were performed using a conventional plug flow model. In these measurements gas streams, simulating lean burn exhaust gas from the engine, were passed over and through meshed particles of test samples under conditions of varying temperature and the effectiveness of the sample in NOx reduction was determined by means of on-line FTIR (Fourier Transform Infra-Red) spectrometer. Two different testing conditions were carried out with NO only and NO₂/NOₓ=25% to simulate the close-coupled and underfloor SCR catalyst position, respectively.

Table 1 below details the full experimental parameters employed in the generation of the data included herein.

TABLE 1
Model Gas testing conditions

| Component/ | Concentration/ | Concentration/ |
|---|---|---|
| Parameter | Setting (NO only) | Setting (25% NO₂) |
| NH₃ | 750 ppm | 750 ppm |
| NO | 500 ppm | 375 ppm |
| NO₂ | | 125 ppm |
| H₂O | 4% | 4% |
| O₂ | 5% | 5% |

| | |
|---|---|
| Temperature | Ramp 600 to 100° C. @ −2° C./min |
| Sample mass | 180 mg |
| Particle size of sample | 300-500 μm |
| GHSV | 250,000 h⁻¹ |

TABLE 2
NOₓ conversion rates and N₂O reduction after hydrothermal
aging at 650° C. for 100 hours of Comparative
Examples 1 to 5 and Examples 1 to 17.

| 650° C., 100 h, hydrothermally aged | |
|---|---|
| NO only | 25% NO₂ |

| | NOx % | N₂O % | NOx % | N₂O % |
|---|---|---|---|---|
| Name | 175° C. | 400° C. | 175° C. | 400° C. |
| CE 1 | 25.91 | 1.32 | 57.71 | 3.39 |
| CE 2 | 61.00 | 2.30 | 74.73 | 3.73 |
| CE 3 | 31.58 | 1.38 | 61.49 | 3.48 |
| CE 4 | 48.15 | 1.32 | | |
| CE 5 | 62.79 | 2.39 | | 3.18 |
| CE 6 | 34.59 | 1.63 | 56.38 | 2.19 |
| CE 7 | 35.38 | 1.10 | 58.14 | 1.64 |
| CE 8 | 27.25 | 1.28 | 57.46 | 2.81 |
| CE 9 | 34.24 | 1.50 | 60.94 | 3.16 |
| CE 10 | 26.09 | 1.44 | 68.31 | 3.06 |
| Ex 1 | 44.60 | 0.54 | 63.23 | 1.40 |
| Ex 2 | 44.95 | 0.85 | 65.49 | 2.11 |
| Ex 3 | 52.17 | 0.87 | 71.12 | 2.06 |
| Ex 4 | 46.79 | 1.10 | 68.54 | 2.46 |
| Ex 5 | 48.29 | 0.64 | 69.04 | 1.59 |
| Ex 6 | 44.88 | 0.86 | 68.17 | 2.04 |
| Ex 7 | 60.19 | 1.84 | 72.75 | 2.61 |
| Ex 8 | 66.11 | 1.85 | 77.08 | 2.87 |
| Ex 9 | 58.24 | 0.87 | 73.69 | 1.94 |
| Ex 10 | 57.54 | 0.68 | 72.75 | 1.61 |
| Ex11 | 47.99 | 0.81 | 67.77 | 1.68 |
| Ex12 | 53.34 | 0.84 | 73.09 | 1.44 |
| Ex13 | 50.76 | 0.95 | 67.67 | 1.65 |
| Ex14 | 52.95 | 0.82 | 74.30 | 1.24 |
| Ex15 | 51.71 | 0.64 | 68.76 | 1.22 |
| Ex16 | 50.18 | 0.78 | 68.75 | 1.65 |
| Ex17 | 49.84 | 0.77 | 68.31 | 1.40 |

The data above show that calcium alone works as a good promoter for the stabilization of copper. However, the N₂O selectivity in percent is still quite high for zeolites that are promoted with copper and calcium only (CE1 to CE7). By introducing a second element such as iron, cerium, zirconium, yttrium, or lanthanum (Ex3, Ex12, Ex13, Ex14, Ex15), the N₂O selectivity in percent can be considerably lowered. Besides, additional benefit for NOₓ conversion in percent at 175° C. was also observed.

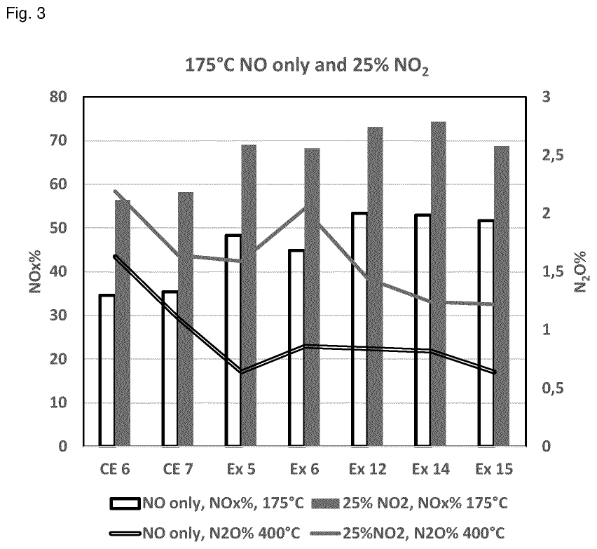

FIG. 3 shows the NOₓ conversion at 175° C. and the N₂O reduction at 400° C., each in percent, for CE6, CE7, Ex5, Ex6, Ex12, Ex14 and Ex15 in the aged state at 175° C. and 400° C. under 25% NO₂ conditions. CE6 and CE7 are promoted with copper and calcium, but no third promoter metal. Ex5, Ex6, Ex12, Ex 14 and Ex15 each additional comprise a third promoter metal, which is a rare earth metal. These five examples according to the present invention show a significantly better NOₓ conversion under both NO only and 25% NO₂ conditions and a lower N₂O selectivity at 400° C. under NO only conditions. The N₂O selectivity of Ex5 at 400° C. under 25% NO₂ conditions is in the same range as that of CE6, whereas Ex6, Ex12, Ex14 and Ex15 show a significantly lower N₂O selectivity than both comparative examples.

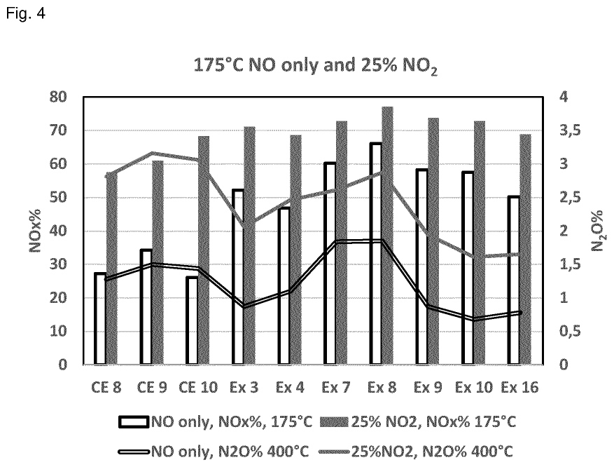

FIG. 4 shows the NOₓ conversion at 175° C. and the N₂O reduction at 400° C., each in percent, for CE8, CE9, CE10, Ex3, Ex4, Ex7, Ex8, Ex9, Ex10 and Ex16 in the aged state at 175° C. and 400° C. under 25% NO₂ conditions. CE8 and CE9 are promoted with copper, iron and potassium, and CE10 is promoted with copper, iron and sodium. By contrast, the examples according to the present invention are all promoted with copper, an alkaline earth metal and iron, and they only differ in their SAR values and/or in their amounts of copper, iron and/or the alkaline earth metal. The alkaline earth metal in Ex3, Ex4 and Ex7 to Ex10 is calcium, and in Ex16, it is magnesium. All examples promoted with copper, iron and an alkaline earth metal calcium show significantly better NOₓ conversions both under NO only and under 25% NO₂ conditions than the comparative examples, wherein the zeolite is promoted with copper, iron and an alkali metal which is potassium or sodium. The N₂O selectivity of Ex7 and Ex8 is comparable with that of CE8, CE9 and CE10 under both NO only and 25 NO₂ conditions, whereas it is significantly lower for the other examples according to the present invention.

1. A crystalline aluminosilicate small-pore zeolite having a maximum ring size of eight tetrahedral atoms, wherein the zeolite comprises
copper, wherein the Cu:Al atomic ratio is between 0.12 and 0.55; an
a metal M1, wherein M1 is calcium, magnesium or strontium, and wherein the M1:Cu atomic ratio is between 0.10 and 0.95; and
a metal M2, wherein M2 is selected from magnesium, calcium, barium, strontium, yttrium, titanium, zirconium, niobium, iron, zinc, silver, lanthanum, cerium, praseodymium, neodymium, promethium, samarium, europium, gadolinium, terbium, dysprosium, holmium, erbium, thulium, ytterbium, lutetium, and mixtures thereof, and wherein the M2:Cu atomic ratio is between 0.05 and 0.80; and wherein M1 and M2 are different from one another, and
wherein the sum of the atomic ratios of copper, metal M1 and metal M2 to aluminum, (Cu+M1+M2):Al, is between 0.20 and 0.80; and
wherein the zeolite comprises at least 2.5 wt.-% of copper, calculated as CuO and based on the total weight of the zeolite.

2. The crystalline aluminosilicate small-pore zeolite having a maximum ring size of eight tetrahedral atoms according to claim 1, wherein the zeolite is selected from ACO, AEI, AEN, AFN, AFT, AFX, ANA, APC, APD, ATT, BIK, CDO, CHA, DDR, DFT, EAB, EDI, EPI, ERI, ESV, ETL, GIS, GOO, IHW, ITE, ITW, LEV, KFI, MER, MON, NSI, OWE, PAU, PHI, RHO, RTH, SAT, SAV, SIV, THO, TSC, UEI, UFI, VNI, YUG, ZON, and mixtures and intergrowths thereof.

3. The crystalline aluminosilicate small-pore zeolite having a maximum ring size of eight tetrahedral atoms according to claim 1, wherein the zeolite is selected from AEI, CHA, AFX, and LEV.

4. The crystalline aluminosilicate small-pore zeolite according to claim 1, wherein the zeolite has a SAR value of 5 to 50.

5. The crystalline aluminosilicate small-pore zeolite according to claim 1, wherein M1 is calcium or magnesium, and M2 is selected from iron, cerium, zirconium, yttrium, samarium, strontium, lanthanum, or barium.

6. A process for the removal of NOx from automotive combustion exhaust gases, wherein a crystalline aluminosilicate zeolite according to claim 1 is used as the SCR catalytically active composition for the conversion of NOx.

7. A catalysed substrate monolith comprising an SCR catalytically active composition for the conversion of NOx for use in treating automotive combustion exhaust gases, wherein said SCR catalytically active composition for the conversion of NOₓ is a crystalline aluminosilicate zeolite according to claim 1.

8. The catalysed substrate monolith according to claim 7, wherein the crystalline aluminosilicate zeolite is present in the form of a washcoat on a carrier substrate.

9. The catalysed substrate monolith according to claim 8, wherein the carrier substrate is a honeycomb flow-through substrate, a honeycomb wall-flow filter, a corrugated substrate, a wound or packed fiber filter, an open cell foam, or a sintered metal filter.

10. The catalysed substrate monolith according to claim 7, wherein the catalysed substrate monolith is an extruded catalysed substrate monolith.

11. The catalysed substrate monolith according to claim 9, wherein the monolith is a flow-through monolith coated with a bottom layer comprising an oxidation catalyst and a top layer comprising the crystalline aluminosilicate zeolite.

12. An emissions treatment system for the removal of NOx emissions from exhaust gases of internal combustion engines, and optionally also for the removal of particulate matter, the system comprising, in the following order, from upstream to downstream:
a) means for injecting ammonia or an ammonia precursor solution into the exhaust gas stream,
b) a catalysed substrate monolith comprising an SCR-catalytically active composition for the conversion of NOx in automotive combustion exhaust gases, wherein said SCR catalytically active compositions for the conversion of NOx is a crystalline aluminosilicate zeolite according to claim 1, and wherein the substrate monolith is selected from honeycomb flow-through substrates, honeycomb wall-flow filters, corrugated substrates, wound or packed fiber filters, open cell foams, sintered metal filters, and extruded catalysed substrate monoliths.

13. The emissions treatment system according to claim 12, wherein said emissions treatment system is arranged in a close-coupled position.

14. The emissions treatment system according to claim 12, wherein said emissions treatment system is arranged in an underfloor position.

15. A method for the removal of NOx emissions from exhaust gases of internal combustion engines, and optionally also for the removal of particulate matter, the method comprising, in the following order, from upstream to downstream:
a) injecting ammonia or an ammonia precursor solution into the exhaust gas stream,
b) introducing the exhaust gas from step a) into a catalysed substrate monolith comprising an SCR-catalytically active composition for the conversion of NOx in automotive combustion exhaust gases, wherein said SCR catalytically active compositions for the conversion of NOx is a crystalline aluminosilicate zeolite according to claim 1, and wherein the substrate monolith is selected from honeycomb flow-through substrates, honeycomb wall-flow filters, corrugated substrates, wound or packed fiber filters, open cell foams, sintered metal filters, and extruded catalysed substrate monoliths.

16. The method according to claim 15, wherein the internal combustion engine is selected from gasoline, diesel, and hydrogen internal combustion engines (H₂ ICE).
